(19) United States
(12) Patent Application Publication
(10) Pub. No.: US 2018/0029241 A1
(43) Pub. Date: Feb. 1, 2018

(54) METHOD OF FORMING CUTTING TOOLS WITH AMORPHOUS ALLOYS ON AN EDGE THEREOF

(71) Applicant: LIQUIDMETAL COATINGS, LLC, Lake Forest, CA (US)

(72) Inventors: Choongnyun Paul KIM, Northridge, CA (US); John Kang, Coto De Caza, CA (US)

(21) Appl. No.: 15/664,844

(22) Filed: Jul. 31, 2017

Related U.S. Application Data
(60) Provisional application No. 62/368,725, filed on Jul. 29, 2016.

(51) Int. Cl. B26B 9/00; C22C 45/02; B23K 26/342; B28B 1/14; B23K 15/00; C22C 45/10; C22C 45/00

(52) U.S. Cl. CPC B26B 9/00; C22C 45/10; C22C 45/02; C22C 45/006; B28B 1/14; B23K 15/0093; B23K 26/342; C22C 2200/02

(57) ABSTRACT

A cutting tool comprising a blade portion having a sharpened edge area and a body portion, wherein the body portion comprises a casted metal or a ceramic, wherein the sharpened edge area comprises at least 50% by volume of amorphous alloy material, the amorphous alloy material being limited to the sharpened edge area, and a method of forming the cutting tool having a blade portion having a sharpened edge and a body portion. The body portion is formed from a metal or a ceramic and the sharpened edge includes an amorphous alloy material thereon, is described. The sharpened edge area may have at least 50% by volume of amorphous alloy material. The amorphous alloy may be chromium-based, iron-based, or zirconium-based. A thickness of the amorphous alloy material on the sharpened edge may be between approximately 2 to 5 microns.

This present application claims priority to U.S. Provisional Application Ser. No. 62/368,725, filed Jul. 29, 2016, which is hereby incorporated by reference in its entirety.

### FIELD

The described embodiments relate generally to cutting tools. More particularly, the present embodiments relate to cutting tools or knives having an edge formed from amorphous material.

### BACKGROUND

### Description of Related Art

Although sharp-edged cutting tools are produced from a variety of materials, each has significant disadvantages. For example, sharp-edged cutting tools are produced from hard materials such as carbides, sapphire and diamonds provide sharp and effective cutting edges; however, these materials have a substantially higher manufacturing cost. In addition, cutting edges of blades made from these materials are extremely fragile due to the materials intrinsically low toughness.

Sharp-edged cutting tools made of conventional metals, such as steel (e.g., carbon steel), can be produced at relatively low cost and can be used as disposable items. However, the cutting performance of these blades does not match that of the more expensive high hardness materials. Steel is too soft and knives made of steel tend to rust and get dull within few months of use. On the other spectrum, ceramic is about 5 times harder than steel, but has only a fraction of steel's ductility. Thus, most ceramic knives tend to lose their edge through chipping or breakage. Ceramic is too brittle to produce sharp durable knives. In some instances, a single miss use can damage or break a ceramic knife. Accordingly, steel and ceramic are not ideal blade materials.

As can be seen by the graphs in FIGS. 3 and 4, steel's hardness is 4 to 6 GPa, which is a fraction of silicon carbide's or nitride's hardness. Although ceramic is 5× harder than steel, ceramic has about 1/10 the ductility of steel. Other materials, such as a bulk nitride or diamond composite material are quite difficult to machine and sharpen. Thus, most material scientists have accepted the mutually exclusive properties of hardness and ductility.

More recently it has been suggested to produce cutting tools made from amorphous alloys. Although amorphous alloys have the potential to provide blades having high hardness, ductility, elastic limit, and corrosion resistance at a relatively low cost, thus far the size and type of blade that can be produced with these materials has been limited by the processes required to produce alloys having amorphous properties. For example, cutting blades made with amorphous alloy are described in U.S. Pat. No. Re 29,989 and U.S. Pat. No. 6,887,586, both of which are hereby incorporated by reference in their entireties. However, the device described in such prior art are limited with regards to manufacturing and realizing the amorphous properties of these alloys. Also, such prior art devices are made entirely with amorphous alloys or coated in their entirety, thus further resulting in higher costs to manufacture.

Accordingly, there is a need for an improved cutting blade having good mechanical properties (including hardness and ductility), a sharp edge, and corrosion resistance that is of lower cost and that takes advantage of amorphous alloy properties.

### SUMMARY

It is an aspect of this disclosure to provide a method for forming a cutting tool. The method includes casting a blade portion of a cutting tool using a metal or a ceramic; fusing a amorphous alloy material to an edge of the casted blade portion; and sharpening the edge of the amorphous alloy material. The sharpened edge area has at least 50% amorphous alloy material.

Another aspect of this disclosure provides a method for forming a cutting tool. The method includes casting a blade portion of a cutting tool using a metal or a ceramic; fusing an amorphous alloy material to an edge of the blade portion; and sharpening the edge of the amorphous alloy material. A thickness of the amorphous alloy material on the edge is up to 5 microns.

Another embodiment relates to a method comprising casting a blade portion of a cutting tool using a metal or a ceramic; fusing a amorphous alloy material to an edge of the casted blade portion; and sharpening the edge of the amorphous alloy material, wherein a thickness of the amorphous alloy material on the edge is up to 5 microns.

The method could further comprise mounting a handle onto the body portion.

Preferably, the fusing of the amorphous alloy material to the edge of the blade portion comprises one of the group of following processes: welding, thermal spraying, laser cladding, electron beam welding, and baking.

Yet another aspect provides a cutting tool with a blade portion having a sharpened edge and a body portion. The body portion is formed from a metal or a ceramic, and the sharpened edge includes an amorphous alloy material. The sharpened edge area has at least 50% amorphous alloy material, and the amorphous alloy material is limited to the sharpened edge area.

Preferably, the amorphous alloy material comprises approximately 20% to approximately 50% by weight of chromium.

Preferably, the amorphous alloy material comprises approximately 30% to approximately 50% by weight of iron.

Preferably, the amorphous alloy material comprises approximately 30% to approximately 60% by weight of zirconium.

Preferably, the amorphous alloy material comprises the following mixture: from approximately 25 to 27% by weight of chromium, from approximately 2 to 2.2% by weight of boron, from approximately 16 to 18% by weight of molybdenum, from approximately 2 to 2.5% by weight of carbon and the remaining percentage by weight being iron, such that the total weight of the components are selected to total 100%.

Preferably, the amorphous alloy material comprises the following mixture: from approximately 3.5 to 11% by weight of titanium, from approximately 13 to 15% by weight of copper, from approximately 10 to 12% by weight of nickel, approximately 2 to 4% by weight of X, and the remaining percentage by weight being zirconium, such that the total weight of the components are selected to total 100%, wherein X comprises: beryllium, aluminum, or a mixture thereof.

Preferably, X comprises a mixture of beryllium and aluminum and wherein the ratio of aluminum to beryllium is 2.5:1.

Preferably, the amorphous alloy material comprises the following mixture: from approximately 43 to 46% by weight of chromium, from approximately 1.5 to 2.5% by weight of silicon, from approximately 5.5 to 6.5% by weight of boron, and the remaining percentage by weight being iron, such that the total weight of the components are selected to total 100%.

Preferably, the amorphous alloy material comprises an ex-situ additive selected from the group of: diamond, sapphire, carbides, and borides.

Preferably, the amorphous alloy material comprises a composite material having 50% by volume of amorphous material.

Preferably, a thickness of the amorphous alloy material is up to approximately 5 microns.

Preferably, the thickness of the amorphous alloy material is between at least approximately 2 microns and approximately 5 microns.

Other aspects, features, and advantages of the present invention will become apparent from the following detailed description, the accompanying drawings, and the appended claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIG. 3 provides a graph showing relative strength and hardness of multiple materials.

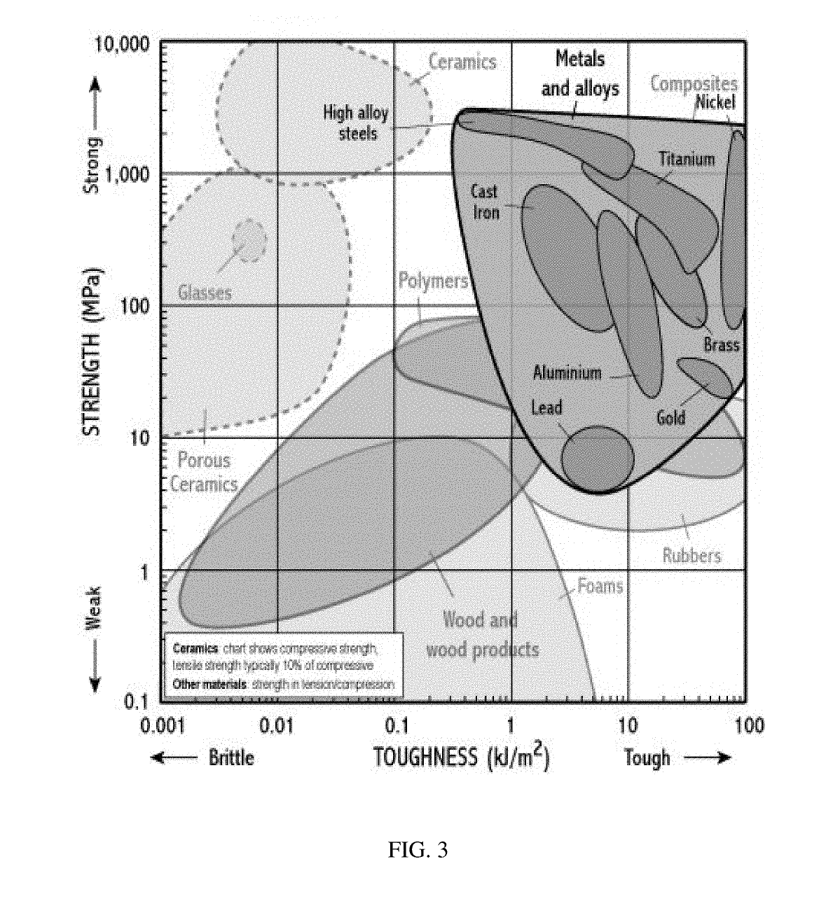

FIG. 4 provides a graph illustrating the hardness of a number of materials.

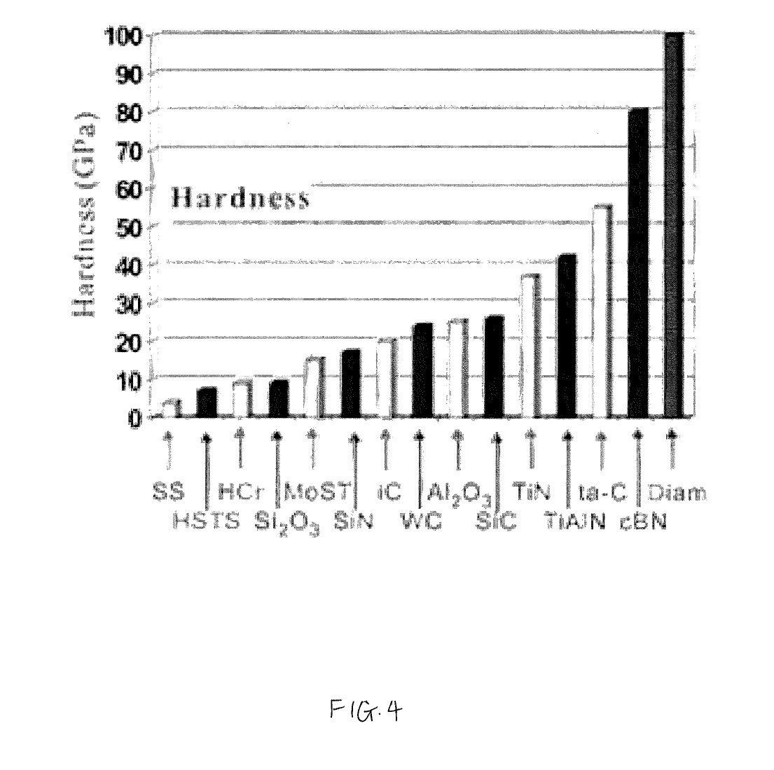

FIG. 5 is a partial side view of a cutting tool in accordance with an embodiment.

FIG. 6 is a flow chart showing a method for making the cutting tool of FIG. 1.

### DETAILED DESCRIPTION OF THE PREFERRED EMBODIMENT(S)

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material.

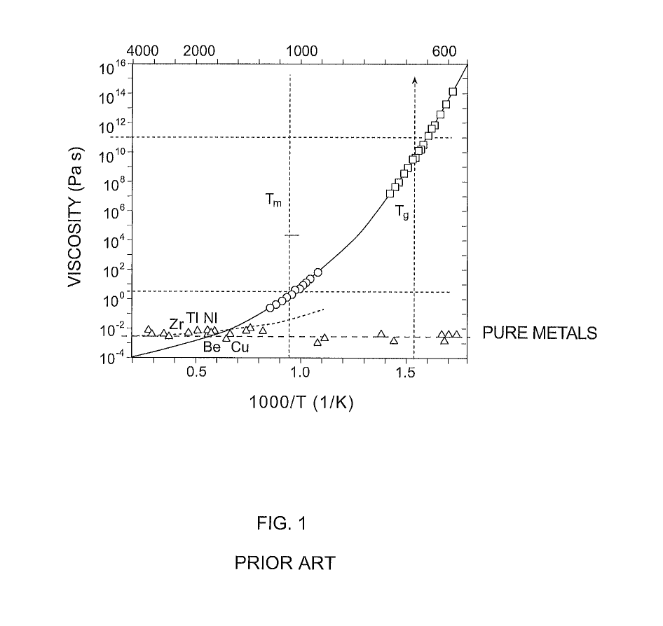

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

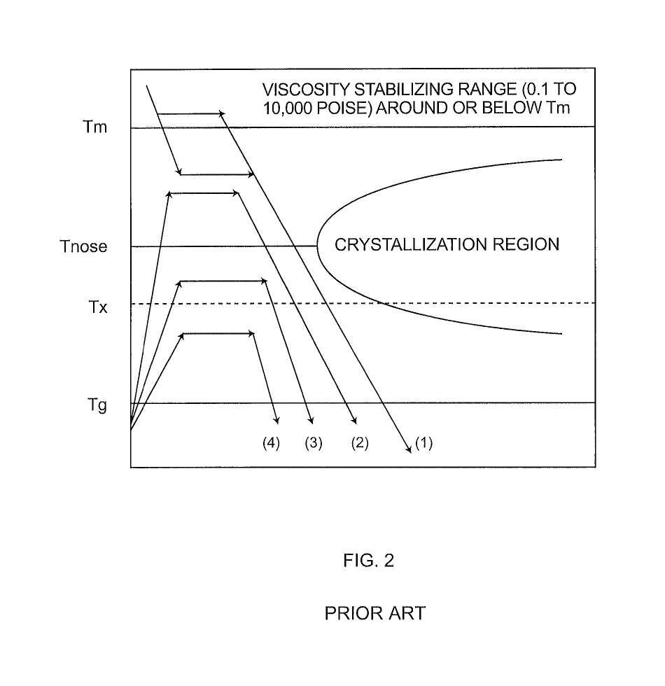

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot or even a portion of a structural component that has dimensions in the millimeter, centimeter, or meter range.

Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x, x′)= [symbol] s(x), s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, cutting tools, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The method described herein (e.g., method 100) can be applicable to any type of amorphous alloy. Similarly, in accordance with embodiments, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 5 | Pt | Cu | Ag | P | B | Si | | |
| | 74.70% | 1.50% | 0.30% | 18.0% | 4.00% | 1.50% | | |

TABLE 2
Additional Exemplary amorphous alloy compositions (atomic %)

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15Mo14Y2C15B6. They also include the alloy systems described by Fe—Cr—Mo—(Y,Ln)-C—B, Co—Cr—Mo-Ln-C—B, Fe—Mn—Cr—Mo—(Y,Ln)-C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5 Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and U.S. Pat. No. 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

In accordance with embodiments herein, the disclosed method 100 produces a final part wherein the additional coating layer fused onto the edge of the cutting tool has a higher thickness (i.e., is thicker on the edge) than a critical casting thickness of the casted alloy body.

Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tx. The cooling step is carried out at rates similar to the heating rates at the heating step, and preferably at rates greater than the heating rates at the heating step. The cooling step is also achieved preferably while the forming and shaping loads are still maintained.

Application to a Cutting Tool

The following disclosure relates to methods for forming cutting tools that includes fusing or applying amorphous alloy material to a sharpened edge area of a cutting tool whose body is casted or formed from a metal or a ceramic. The sharpened edge area may include at least 50% bulk amorphous alloy. Also disclosed is a cutting tool with a blade portion having a sharpened edge and a body portion. The body portion is formed from a metal or a ceramic, and the sharpened edge includes a amorphous alloy material applied in the manner noted above. The sharpened edge area may include at least 50% bulk amorphous alloy. A thickness of the bulk amorphous alloy material on the edge may be between approximately 2-5 microns, for example.

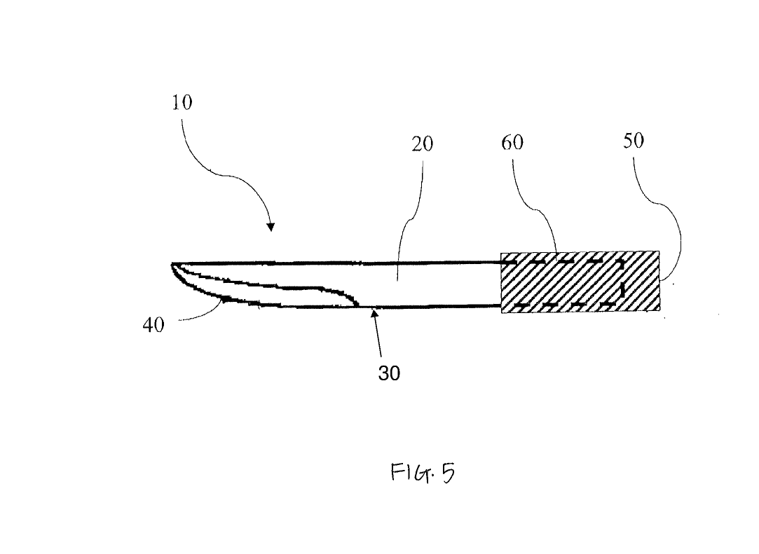

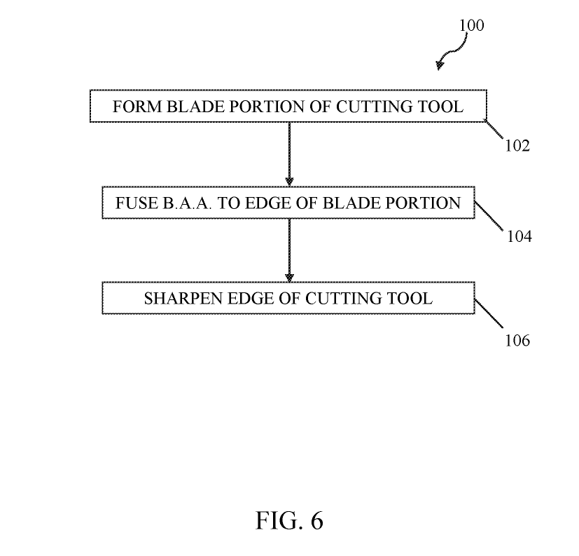

These and other embodiments are discussed below with reference to FIGS. 5-6. However, those skilled in the art will readily appreciate that the detailed description given herein with respect to these Figures is for explanatory purposes only and should not be construed as limiting.

In addition to the effects of hardness and ductility on durability of cutting tools or knives previously discussed, other factors contribute to the rapid loss of edge durability. As previously noted, ceramic tends to chip or break easily. Thus, any durability gained through its hardness is easily lost through lack of ductility. Also, because cutting tools made of ceramic cannot be used to cut a number of items, such as for cutting frozen foods and bones, a consumer typically has a duplicate set of [steel] knives to such tasks. Further, although inert ceramic surfaces include an anti-bacterial advantage, since it is recommended that ceramic cutting tools are only used on wood cutting boards, which are notoriously germ infested, any such advantages are essentially lost.

Corrosion, Abrasion, Chipping, and Folding edge are four main mechanisms by which steel blades lose their cutting ability, with the largest contributing factor being corrosion. Carbon steel has minimal corrosion resistance. Even a thin layer of corrosion on a surface causes the top layer to rust (Iron Oxide), which can easily be removed. Abrasion via food products and/or contact with a cutting board, for example, easily removes this oxide layer, thus exposing the next layer to repeat the corrosion and abrasion cycle. Further, since cutting tools like kitchen knives are regularly exposed to moisture and salt, the durability of blades made of steel is significantly less than what is represented by the initial surface hardness. Although carbon Steel has 4-6 GPa hardness, the oxide layer has a fraction of steel's durability, and can even be removed by wiping with a sponge.

Accordingly, keeping such factors in mind, one can conclude that an ideal blade material has three properties:

Hardness of approximately 20 GPa to approximately 30 GPa (both inclusive), to provide maximum wear resistance while allowing the edge to be shaped and sharpened;

Ductility in a similar range as that of carbon steel, to minimize chipping and breakage; and

Corrosion Resistance similar to that of ceramic or stainless steel, to blunt the oxidation of a surface and subsequent softening of the surface.

Amorphous alloy materials have these three properties. An amorphous alloy material has a combination of a ductile base and a hard surface which transforms itself to an amorphous layer with extreme corrosion and wear resistance.

FIG. 5 shows an exemplary cutting tool 10 that may be formed based on the disclosed method 100 (as described later with reference to FIG. 6) in accordance with an embodiment of this disclosure. The cutting tool 10 may be a knife or scalpel, for example. The cutting tool 10 has a body portion 20 having a blade portion 30 with an edge area 40 that is sharpened (also referred to as a “sharpened edge” or “sharpened edge area”). In accordance with an embodiment, the blade portion 30 is formed from a metal or a ceramic, and the sharpened edge 40 includes an amorphous alloy material.

In one embodiment, the sharpened edge area 40 is at least partially formed from the same material as the body portion, i.e., the sharpened edge area 40 is partially formed of metal or ceramic and further includes a coating of the amorphous alloy provided thereon in the edge area 40. The amorphous alloy may be provided over the body material (of the blade portion 30) only within the sharpened edge area 40.

In accordance with an embodiment, the sharpened edge area 40 includes at least 50% amorphous alloy material. In another embodiment, the sharpened edge area 40 includes at least 75% amorphous alloy material.

In one embodiment, the amorphous alloy material on or in the edge area 40 includes a composite material having 50% by volume of amorphous material.

In accordance with another embodiment, the sharpened edge area 40 is essentially formed from amorphous alloy in the edge area 40 and fused to the material of the blade portion 30.

In accordance with an embodiment, a thickness of the transformed layer to amorphous structure thickness of the amorphous alloy material provided on the edge 40 is between at least approximately 2 microns and approximately 5 microns. In one embodiment, the amorphous surface layer is approximately 2 to 3 microns thick. In accordance with another embodiment, the thickness of the amorphous alloy provided on or in the edge area is up to 5 microns of amorphous transformed layer thickness.

In its crystalline phase, amorphous alloys are relatively easy to machine.

Accordingly, a surface of the blade may be easily machined. However, when the surface layer has morphed into its amorphous phase, durability goes up 3× to 5×, making it extremely hard to reshape and grind down. For this reason, if forces applied to the amorphous layer of the edge remain below a certain threshold, the sharpened edge of the herein disclosed blade may last significantly longer than the 3× to 5× improvement shown during the accelerated tests. The force threshold is dependent upon the type of amorphous alloy used in or on the edge area of the cutting tool.

In one embodiment, the amorphous material is a nanocrystalline material. In an embodiment, the amorphous alloy has an elastic limit up to 2%.

In one embodiment, the amorphous alloy used on the edge of the blade has a mix of chrome borides in steel matrix.

In an embodiment, the amorphous alloy material of the sharpened edge area 40 of the cutting tool 10 as disclosed herein comprises a mixture having approximately 20% to approximately 50% by weight of chromium therein.

In an embodiment, the amorphous alloy material of the sharpened edge area 40 of the cutting tool 10 as disclosed herein comprises a mixture having approximately 30% to approximately 50% by weight of iron therein.

In an embodiment, the amorphous alloy material of the sharpened edge area 40 of the cutting tool 10 as disclosed herein comprises a mixture having approximately 30% to approximately 60% by weight of zirconium therein.

Any of the above compositions of amorphous alloy material may be formed as a result of using the method 100 disclosed herein. The method may fuse such material to the edge of the blade, for example. The following are additional examples of compositions of amorphous material that may be used on or in the sharpened edge 40 of the blade in accordance with embodiments herein, and in the method 100 of forming the cutting tool. Note that the percentages in the below examples refer to weight percentages (not atomic percentages).

In one embodiment, the amorphous alloy of the sharpened edge 40 includes the following mixture: from approximately 25 to 27% by weight of chromium, from approximately 2 to 2.2% by weight of boron, from approximately 16 to 18% by weight of molybdenum, from approximately 2 to 2.5% by weight of carbon and the remaining percentage by weight being iron, such that the total weight of the components are selected to total 100%. The blade portion 30 may include casted or molded metal or ceramic.

In another embodiment, the amorphous alloy of the sharpened edge 40 includes the following mixture: from approximately 43 to 46% by weight of chromium, from approximately 1.5 to 2.5% by weight of silicon, from approximately 5.5 to 6.5% by weight of boron, and the remaining percentage by weight being iron, such that the total weight of the components are selected to total 100%. The blade portion 30 may include casted or molded metal or ceramic.

In yet another embodiment, the amorphous alloy of the sharpened edge 40 includes the following mixture: wherein the amorphous alloy comprises the following mixture: approximately 11% of titanium, approximately 13% copper, approximately 10% nickel, approximately 3.5% beryllium, and the remaining percentage by weight being zirconium, such that the total weight of the components are selected to total 100%. The blade portion 30 may include casted or molded metal or ceramic.

In still yet another embodiment, the amorphous alloy of the sharpened edge 40 includes the following mixture: wherein the amorphous alloy comprises the following mixture: from approximately 3.5 to 11% by weight of titanium, from approximately 13 to 15% by weight of copper, from approximately 10 to 12% by weight of nickel, approximately 2 to 4% by weight of X, and the remaining percentage by weight being zirconium, such that the total weight of the components are selected to total 100%, wherein X comprises: beryllium, aluminum, or a mixture thereof. The blade portion 30 may include casted or molded metal or ceramic. In one embodiment, X comprises a ratio of aluminum to beryllium that is 2.5:1.

In another embodiment, the amorphous alloy of the sharpened edge 40 includes the following mixture: approximately 5% by weight of titanium, approximately 15% by weight of copper, approximately 11% by weight of nickel, approximately 1% by weight of beryllium and approximately 2.5% by weight of aluminum, and the remaining percentage by weight being zirconium, such that the total weight of the components are selected to total 100. The blade portion 30 may include casted or molded metal or ceramic.

In yet another embodiment, the amorphous alloy of the sharpened edge 40 includes the following mixture: approximately 11% by weight of titanium, approximately 13% by weight of copper, approximately 10% by weight of nickel, approximately 3.5% by weight of beryllium, and the remaining percentage by weight being zirconium, such that the total weight of the components are selected to total 100. The blade portion 30 may include casted or molded metal or ceramic.

In another embodiment, the amorphous alloy of the sharpened edge 40 includes the following mixture: approximately 3.5% by weight of titanium, approximately 15% by weight of copper, approximately 12% by weight of nickel, approximately 3.5% by weight of aluminum, and the remaining percentage by weight being zirconium, such that the total weight of the components are selected to total 100. The blade portion 30 may include casted or molded metal or ceramic.

In addition, in those cases in which a handle 50 is formed on or attached to the body portion 20 of the cutting tool 10, materials such as plastic, wood, etc., may be used to form the handle. Furthermore, although the embodiment of the cutting tool shown in FIG. 6 shows a traditional longitudinal knife body 20 with a handle 50 attached on a long shank 60 at the end of the body opposite the blade 30, any configuration may be made and, likewise, the handle 50 may be positioned anywhere on the body of the cutting tool such that force applied from a user can be transmitted through the handle to the body to the blade and cutting edge of the cutting tool.

A method of manufacturing cutting tools using amorphous alloys, such as the cutting tool 10 of FIG. 5, is now described. FIG. 6 shows a flowchart for the method 100 or process of forming amorphous alloy edges of cutting tools. The method 100 includes forming a blade portion 30 of a cutting tool 10 using a metal or a ceramic (e.g., via a casting or molding process), as shown at 102; fusing an amorphous alloy material to an edge 40 of the blade portion 30, as shown at 104; and sharpening the edge 40 of amorphous alloy material, as shown at 104, to thereby form the body portion 20 of the cutting tool 10. The sharpening step at 104 may include first forming a preliminary edge and then a final sharp edge by implementing one or more combinations of conventional lapping, chemical and high energy methods, for example.

As previously noted, in one embodiment, the thickness of the amorphous alloy material on the edge 40 may be up to 5 microns, for example.

Also, in accordance with embodiments herein, the fusing step at 102 may include considerations and/or further steps such that at least the sharpened edge has at least 50% amorphous alloy material. In one non-limiting embodiment, the amorphous alloy is metallurgically bonded to the substrate of the blade portion 30.

Further, an optional step (not shown) of connecting the handle 50 and the body portion 20 to form the cutting tool 10 may be included in the method 100.

The application of the amorphous alloy as disclosed herein is not molded or cast as part of the blade portion 30. Instead, the amorphous alloy is applied and fused to the edge area 40 of the blade portion 30 via one or more secondary process(es), including, but not limited to: welding, thermal spraying, laser cladding, electron beam welding, or baking. That is, the blade portion 30—including the body portion 20 and optionally part of the edge area 40—may be first formed via a first process (which may be via casting or molding) using a material such as steel or ceramic. Thereafter, the amorphous alloy may be applied to the edge area 40 via at least one second process for fusing with the material of the blade portion 30.

Optionally, in accordance with an embodiment, the edge area 40 is subject to further processes, including, for example, finishing processes, as part of the method 100 (also not shown in FIG. 6). It should be understood that the amorphous alloy can be further treated to improve aesthetics and colors of the cutting tool. For example, the cutting tool may be subject to any suitable electrochemical processing, such as anodizing (electrochemical oxidation of the metal). Since such anodic coatings also allow secondary infusions, (i.e. organic and inorganic coloring, lubricity aids, etc.), additional aesthetic or functional processing could be performed on the anodized cutting tools. Any suitable conventional anodizing process may be utilized.

Although subsequent processing steps may be optionally used to finish the amorphous alloy edge, it should be understood that the mechanical properties of the amorphous alloys and composites can be obtained without any need for subsequent process such as heat treatment or mechanical working.

The method 100 of forming the blade portion 30 of the body portion 20 of the cutting tool 10 is not limited. For example, in the case of a molding process being used to form the blade portion 30, feedstock as a solid piece or semi-solid piece may be fed and molded via a casting process into a desired shape by injecting molten material into a cavity (which may be under vacuum), cooling the material to a solid shape in the mold, and then ejecting the molded blade portion 30. If necessary, edges may be filed or trimmed.

In addition, the compositions and examples of amorphous alloy as previously described are not intended to be limiting. For example, it should be understood that additives or ex-situ materials, e.g., diamond, sapphire, carbides, borides, etc., may be added to the amorphous alloy (e.g., in powder form) that is fused to the edge of the casted blade portion. Accordingly, the examples described herein are not intended to limit or exclude materials or additives that assist in adding strength, sharpness, and/or hardness to the amorphous alloy and thus the edge of the cutting tool.

Although only a relatively simple single blade knife-like cutting tool is shown in FIG. 5, it should be understood that other processes and configurations of the blade may be employed. For example, at least part of the blade 30 and/or edge 40 may be serrated. In an embodiment, the disclosed amorphous alloy on the sharpened edge 40 is 4 to 5 times harder than the ductile material used to form the blade portion 30. In some cases, the differential in hardness of the matrix automatically results in a micro serrated edge.

Prior art products and methods (like those described in the incorporated references) generally aim to make a whole knife blade amorphous; however, such products can break easily due to the low elastic limit of amorphous alloys. By just making the edge 40 of amorphous alloy material, the full benefits of the higher hardness of an amorphous surface are achieved, while still maintaining the benefit of the full ductility of the base material used to form the body portion 20. Further, costs of materials and manufacturing are lowered, since the amorphous material is concentrated on the edge area (as opposed to forming the entire blade of amorphous material, or coating the entire blade with amorphous material).

As such, the disclosed blade has an edge of great hardness while still providing a body that is ductile (and not brittle). Placing a hard surface of amorphous alloy on the edge of a cutting tool provides a higher hardness to retain the edge longer. That is, fusing a harder but ductile bulk amorphous alloy to a softer base metal or ceramic as disclosed herein provides a cutting tool or knife with a hard but that is totally metallogically bonded (due to the properties of the amorphous material).

Providing such material on the edge 40 of a cutting tool results in an edge that is at least two to three times (2× to 3×) times sharper and more durable than other materials used to form the base or blade (such as steel), and without resorting to extreme sharpening techniques. The combination of a softer and more ductile base with the highly durable surface layer of amorphous alloy (provided as part of the edge, e.g., in the form of a coating) provides an optimal combination of ductility and durability which is not typically available in other known combinations of materials.

It may also be noted that the herein described cutting tool 10 has the advantage of its sharpened edge 40 transforming into amorphous structure and providing the effect of self-healing specific to any area where it may be needed. Specifically, the process of friction on the edge 40 wears the amorphous layer thereon down, but it concurrently morphs the next layer into an amorphous phase, thereby causing self-healing where it is worn.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings. Therefore, this disclosure includes all modifications encompassed within the spirit and scope of the following claims.

What is claimed is:

1. A method comprising:
casting a blade portion of a cutting tool using a metal or a ceramic;
fusing an amorphous alloy material to an edge of the casted blade portion; and
sharpening the edge of the amorphous alloy material,
wherein the sharpened edge area comprises at least 50% by volume of the amorphous alloy material or a thickness of the amorphous alloy material on the edge is up to 5 microns.

2. The method according to claim 1, further comprising mounting a handle onto the body portion.

3. The method according to claim 1, wherein the fusing of the amorphous alloy material to the edge of the blade portion comprises welding, thermal spraying, laser cladding, electron beam welding, baking or combinations thereof.

4. The method according to claim 1, wherein the amorphous alloy material comprises approximately 20% to approximately 50% by weight of chromium.

5. The method according to claim 1, wherein the amorphous alloy material comprises approximately 30% to approximately 50% by weight of iron.

6. The method according to claim 1, wherein the amorphous alloy material comprises approximately 30% to approximately 60% by weight of zirconium.

7. The method according to claim 1, wherein the amorphous alloy material comprises the following mixture: from approximately 25 to 27% by weight of chromium, from approximately 2 to 2.2% by weight of boron, from approximately 16 to 18% by weight of molybdenum, from approximately 2 to 2.5% by weight of carbon and the remaining percentage by weight being iron, such that the total weight of the components are selected to total 100%.

8. The method according to claim 1, wherein the amorphous alloy material comprises the following mixture: from approximately 3.5 to 11% by weight of titanium, from approximately 13 to 15% by weight of copper, from approximately 10 to 12% by weight of nickel, approximately 2 to 4% by weight of X, and the remaining percentage by weight being zirconium, such that the total weight of the components are selected to total 100%, wherein X comprises: beryllium, aluminum, or a mixture thereof.

9. The method according to claim 8, wherein X comprises a mixture of beryllium and aluminum and wherein the ratio of aluminum to beryllium is 2.5:1.

10. The method according to claim 1, wherein the amorphous alloy material comprises the following mixture: from approximately 43 to 46% by weight of chromium, from approximately 1.5 to 2.5% by weight of silicon, from approximately 5.5 to 6.5% by weight of boron, and the remaining percentage by weight being iron, such that the total weight of the components are selected to total 100%.

11. The method according to claim 1, wherein the amorphous alloy material comprises an ex-situ additive selected from the group of: diamond, sapphire, carbides, and borides.

12. The method according to claim 1, wherein the amorphous alloy material comprises a composite material having 50% by volume of amorphous material.

13. A cutting tool comprising:
a blade portion having a sharpened edge area and a body portion,
wherein the body portion comprises a casted metal or a ceramic,
wherein the sharpened edge area comprises at least 50% by volume of amorphous alloy material, the amorphous alloy material being limited to the sharpened edge area.

14. The cutting tool according to claim 13, wherein a thickness of the amorphous alloy material is up to approximately 5 microns.

15. The cutting tool according to claim 14, wherein the thickness of the amorphous alloy material is between at least approximately 2 microns and approximately 5 microns.

16. The cutting tool according to claim 13, wherein the amorphous alloy material comprises approximately 20 to 50% by weight of chromium.

17. The cutting tool according to claim 13, wherein the amorphous alloy material comprises approximately 30% to approximately 50% by weight of iron.

18. The cutting tool according to claim 13, wherein the amorphous alloy material comprises approximately 30% to approximately 60% by weight of zirconium.

19. The cutting tool according to claim 13, wherein the amorphous alloy material comprises the following mixture: from approximately 25 to 27% by weight of chromium, from approximately 2 to 2.2% by weight of boron, from approximately 16 to 18% by weight of molybdenum, from approximately 2 to 2.5% by weight of carbon and the remaining percentage by weight being iron, such that the total weight of the components are selected to total 100%.

20. The cutting tool according to claim 13, wherein the amorphous alloy material comprises the following mixture: from approximately 3.5 to 11% by weight of titanium, from approximately 13 to 15% by weight of copper, from approximately 10 to 12% by weight of nickel, approximately 2 to 4% by weight of X, and the remaining percentage by weight being zirconium, such that the total weight of the components are selected to total 100%, wherein X comprises: beryllium, aluminum, or a mixture thereof, wherein X comprises a mixture of beryllium and aluminum and wherein the ratio of aluminum to beryllium is 2.5:1.

21. The cutting tool according to claim 13, wherein the amorphous alloy material comprises the following mixture: from approximately 43 to 46% by weight of chromium, from approximately 1.5 to 2.5% by weight of silicon, from approximately 5.5 to 6.5% by weight of boron, and the remaining percentage by weight being iron, such that the total weight of the components are selected to total 100%.

22. The cutting tool according to claim 13, wherein the amorphous alloy material comprises an ex-situ additive selected from the group of: diamond, sapphire, carbides, and borides.
